(19) United States
(12) Patent Application Publication
(10) Pub. No.: US 2002/0166121 A1
(43) Pub. Date: Nov. 7, 2002

(54) System and method for providing television programs on demand

(76) Inventor: Luis A. Rovira, Atlanta, GA (US)

Correspondence Address: SCIENTIFIC-ATLANTA, INC., INTELLECTUAL PROPERTY DEPARTMENT, 5030 SUGARLOAF PARKWAY, LAWRENCEVILLE, GA, 30044, US

(21) Appl. No.: 09/847,625

(22) Filed: May 2, 2001

(51) Int. Cl. H04N 5/445; H04N 7/173

(52) U.S. Cl. 725/41; 725/37; 725/87; 725/91

(57) ABSTRACT

A user is provided with an interactive program guide identifying future television programs that are scheduled to be broadcast at a later time. After the user selects a future television program, the user is provided with the future television program in advance of its scheduled broadcast time.

### FIELD OF THE INVENTION

This invention relates in general to television systems, and more particularly, to the fields of video-on-demand and electronic program guides.

### BACKGROUND OF THE INVENTION

With recent advances in digital transmission technology, cable television systems are now capable of providing much more than the traditional analog broadcast video. In implementing enhanced programming, the home communication terminal (“ACT”), otherwise known as the settop box, has become an important computing device for accessing video services and navigating users through a maze of available services. In addition to supporting traditional analog broadcast video functionality, digital HCTs (or “DHCTs”) now also support an increasing number of two-way digital services such as video-on-demand.

Typically, a DHCT is connected to a cable or satellite television network and includes hardware and software necessary to provide the functionality of the digital television system at the client's site. Preferably, some of the software executed by a DHCT is downloaded and/or updated via the cable television network. Each DHCT also typically includes a processor, communication components and memory, and is connected to a television or other display device, such as a personal computer. While many conventional DHCTs are stand-alone devices that are externally connected to a television, a DHCT and/or its functionality may be integrated into a television or personal computer, as will be appreciated by those of ordinary skill in the art.

Despite recent advances in technology, many viewers still miss television programs that they had intended to watch. This happens for various reasons; some may simply forget to watch them; some may plan on recording future programs but forget to set their video cassette recorder (VCR) timers; some may not record future programs because their VCR timers seem confusing or difficult to set (especially when operating in conjunction with a cable television box); some may not even have a VCR; some may not like watching programs after they have been broadcast. As a result, there is a need for a system and method that provide users with better access to television programs.

### SUMMARY OF THE INVENTION

A preferred embodiment of the invention is directed to a system and method for providing media services via an interactive media services client device coupled to a programmable media services server device. A method of the present invention includes providing a user with an interactive program guide identifying a future television program that is scheduled to be broadcast at a later time, receiving user input requesting the future television program, and providing the user with the future television program in advance of its scheduled broadcast time.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood with reference to the following drawings. The components in the drawings are not necessarily drawn to scale, emphasis instead being placed upon clearly illustrating the principles of the present invention. In the drawings, like reference numerals designate corresponding parts throughout the several views.

FIG. 1 is a block diagram of an example cable television system in accordance with one preferred embodiment of the present invention.

FIG. 2 is a block diagram of an example headend depicted in FIG. 1.

FIG. 3 is a block diagram of an example DHCT and related equipment, in accordance with one preferred embodiment of the present invention depicted in FIG. 1.

FIG. 4 is a diagram of an example remote control device that can be used to provide user input to the DHCT shown in FIG. 3.

FIG. 5 is a diagram of an example interactive program guide screen that is initially presented to a user by the DHCT depicted in FIG. 3.

FIG. 6 is a diagram of an example interactive program guide screen that is presented to a user subsequent to the screen illustrated in FIG. 5 in response to user activation of an arrow button on the remote control device depicted in FIG. 4.

FIG. 7 is a diagram of an example barker that is presented to a user after a user selects an unavailable program via the screen depicted in FIG. 6.

FIG. 8 is a diagram of an example barker that is presented to a user after the user selects an available program via the screen depicted in FIG. 6.

FIG. 9 is a diagram of an example personal identification number (PIN) barker that is presented to a user after the user selects a television program for which a PIN entry is required.

FIG. 10 is a diagram of an example fee notice barker that is presented to a user after the user selects a television program for which the user will be charged a fee.

FIG. 11 is a diagram of an example date selection screen that is presented to a user after the user activates a “D” button on the remote control device depicted in FIG. 4 while being presented with the IPG screen depicted in FIG. 6.

FIG. 12 is a diagram of an example IPG screen that is presented to a user after the user selects “Thu 2/1” via the date selection screen depicted in FIG. 11.

FIG. 13 is a diagram of an example of a browse-by screen that is presented to a user after the user activates the “B” button on the remote control device depicted in FIG. 4 while being presented with the IPG screen depicted in FIG. 5.

FIG. 14 is a diagram of an example television series selection screen that is presented to a user after the user selects the “television series” option while being presented with the browse-by screen depicted in FIG. 13.

FIG. 15 is a diagram of an example sit-com selection screen that is presented to a user after the user selects the “sit-com” option while being presented with the television series selection screen depicted in FIG. 14.

FIG. 16 is a diagram of an example episode selection screen that is presented to a user after the user selects the “Friends” option while being presented with the sit-com selection screen depicted in FIG. 15.

FIG. 17 is a diagram of an example episode selection screen that is presented to a user after the user activates the down arrow button on the remote control device depicted in FIG. 4 while being presented with the episode selection screen depicted in FIG. 15.

### DETAILED DESCRIPTION OF THE PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

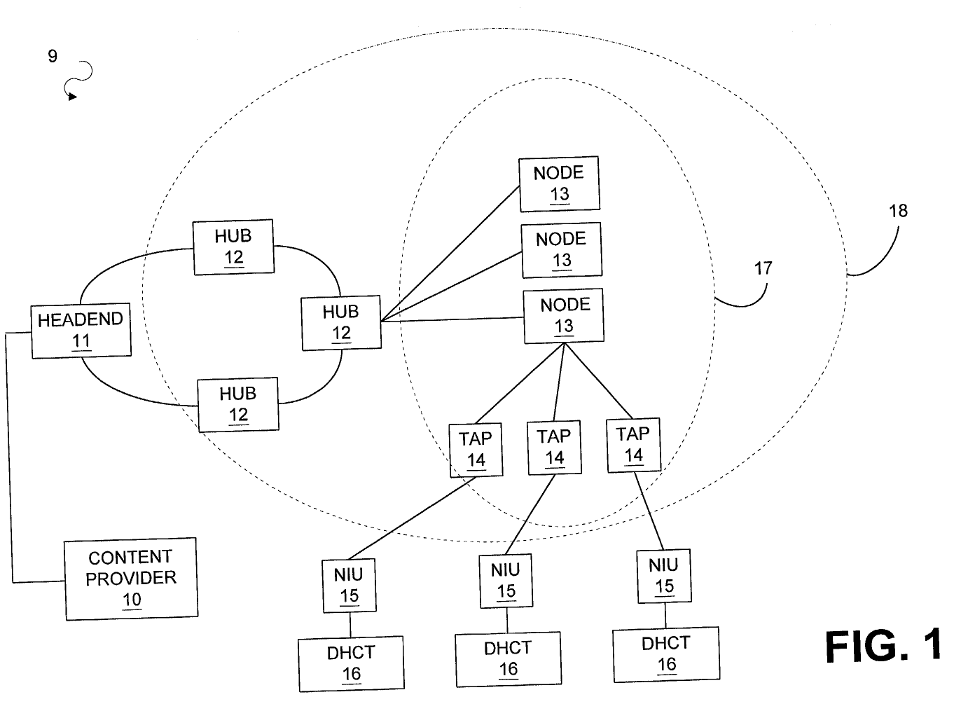

The present invention may, in one embodiment, be implemented as part of a cable television system (CTS). Hence, an illustrative CTS 9 and its operation will be described initially. FIG. 1 shows a block diagram view of a CTS 9, which is generally a high quality, reliable and integrated network system that features video, audio, voice and data services to DHCT users. Although FIG. 1 depicts a high level view of a CTS 9, it should be appreciated that a plurality of cable television systems can tie together a plurality of regional networks into an integrated global network so that DHCT users can receive content provided from anywhere in the world.

The CTS 9 delivers broadcast video signals as digitally formatted signals in addition to delivering traditional broadcast analog video signals. Furthermore, the system can support one way broadcast services as well as both one-way data services and two-way media and data services. The two-way operation of the network allows for user interactivity with services, such as Pay-Per-View programming, Near Video-On-Demand (NVOD) programming according to any of several known NVOD implementation methods, View-on-Demand (VOD) programming (according to any of several known VOD implementation methods), and interactive applications, such as Internet connections and interactive program guide (IPG) applications.

The CTS 9 also provides the interfaces, network control, transport control, session control, and servers to access content and services, and distributes content and services to DHCT users. As shown in FIG. 1, a typical CTS 9 comprises a headend 11, hubs 12, an HFC access network 17, and users' digital home communication terminals (DHCTs) 16. It should be appreciated that although a single component (e.g. a headend) is illustrated in FIG. 1, a CTS 9 can feature a plurality of any one of the illustrated components or may be configured with alternative embodiments for any one of the individual components or with yet other additional components not enumerated above. A content provider 10 transmits media content to a headend for further transmission to users downstream in the network.

Content provided by a content provider 10 is communicated by the content provider 10 to one or more headends 11. From those headends the content is then communicated over a communications network 18 that includes a plurality of HFC access networks 17 (only one HFC access network 17 is illustrated). The HFC access network 17 typically comprises a plurality of HFC nodes 13, each of which may serve a local geographical area. The hub 12 connects to the HFC node 13 through a fiber portion of the HFC access network 17. The HFC node 13 is connected to a tap 14 which is connected to a network interface unit (NIU) 15 which is connected to a DHCT 16. The NIU 15 is normally located at a user's property and provides a transparent interface between the HFC node 13 and the users' internal wiring. Coaxial cables are typically used to couple nodes 13, taps 14 and NIUs 15 because the electrical signals can be easily repeated with radio frequency (RF) amplifiers.

As the high-level operations of many of the functions of CTSs 9 are well known to those of skill in the art, further description of the overall CTS 9 of FIG. 1 will not be contained herein. It will be appreciated, however, that the CTS 9 shown in FIG. 1 is merely illustrative and should not be construed as implying any limitations upon the scope of the present invention. For instance, subscriber television systems also included within the scope of the invention include systems not utilizing physical structured cabling for transmission, such as, for example, satellite systems. Further, transmission mediums included within the scope of the invention include, but are not limited to, HFC, optical, satellite, RF, FM, and microwave. Further, data provided from the headend 11 to the DHCTs 16 and programming necessary to perform the functions discussed below will be understood to be present in the CTS 9, in accordance with the description below.

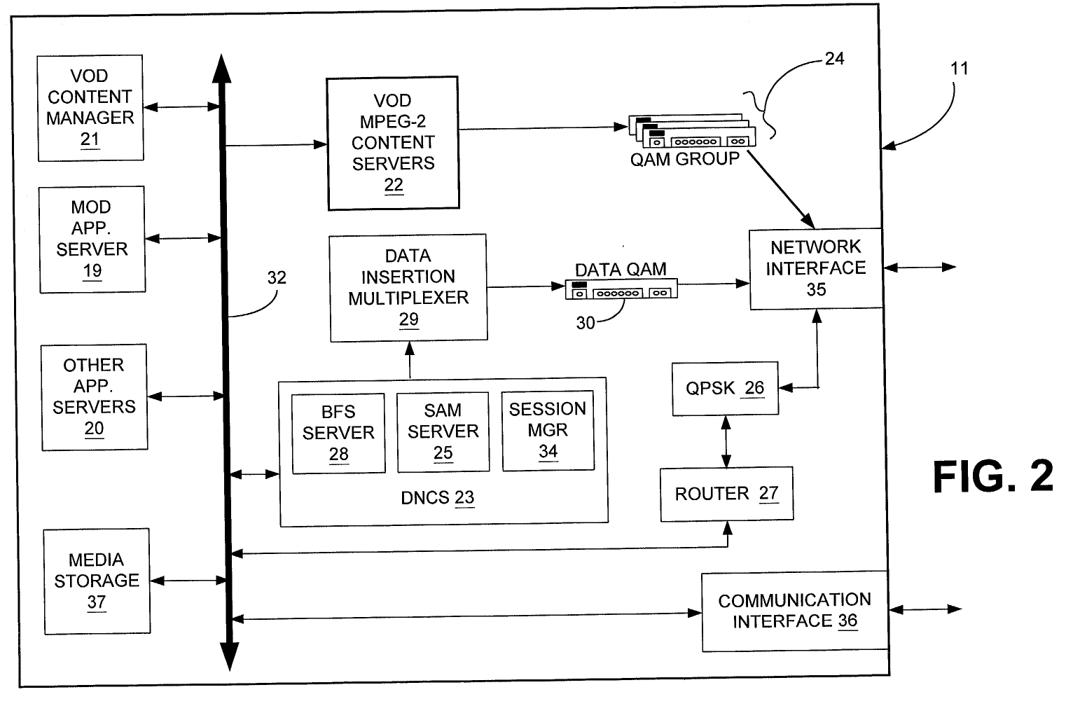

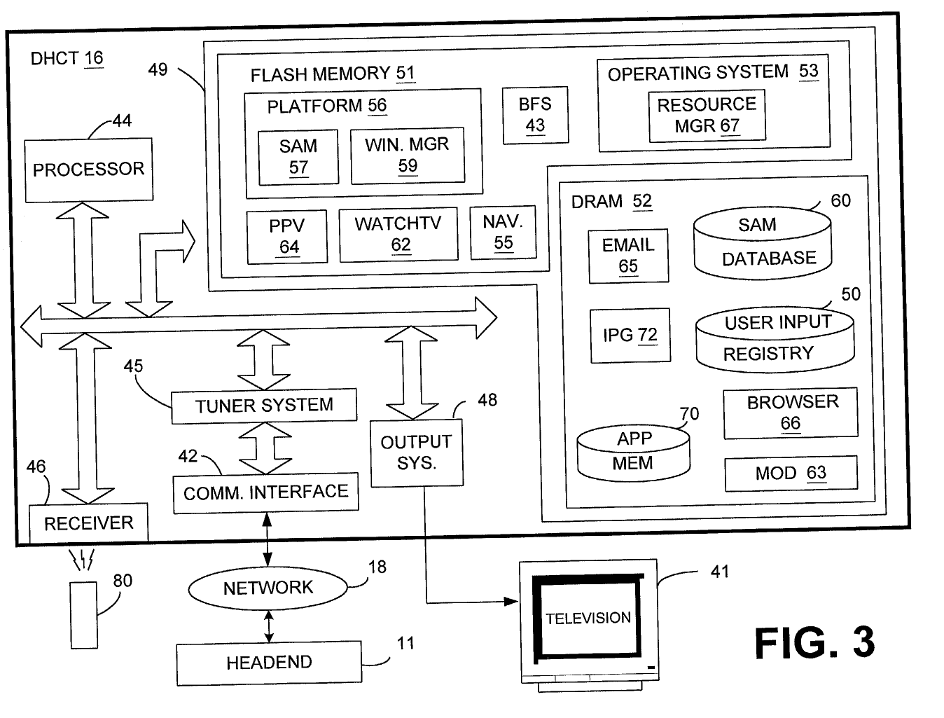

With additional reference to FIG. 1, FIG. 2 is a block diagram showing selected components of an example headend 11 that is configured to provide media-on-demand (MOD) services in accordance with one embodiment of the present invention. MOD services include, among other things, video-on-demand (VOD) services and respective MOD information that may be presented to and selected by a user via an interactive media guide. MOD application server 19 and a plurality of other application servers 20 are connected to a digital network control system (DNCS) 23 via a high-speed network such as an Ethernet connection 32. The MOD application server 19 is responsible for reserving and configuring system resources needed to provide MOD services and for providing configuration and service data to an MOD client application 63 (FIG. 3), including MOD information comprising a catalog of titles available for on-demand viewing and/or on-demand rental by a user.

The DNCS 23 provides complete management, monitoring, and control of the network's elements and of the broadcast services provided to users. In one implementation, the DNCS 23 uses a data insertion multiplexer 29 and a quadrature amplitude modulation (QAM) modulator 30 to insert in-band broadcast file system (BFS) data into an MPEG-2 transport stream that is broadcast and received via DHCT's communication interface 42 and tuner system 45 (FIG. 3). The DNCS 23 also contains a session manager 34 that uses a Digital Storage Media Command and Control (DSMCC) protocol to set up and maintain MOD sessions. The session manager 34 processes user to network (U-N) session signaling messages, manages allocation of session-related network resources, supports network management operations, acts as a point of contact to the network for the DHCT's 16 in the network 18 to establish individual sessions, and supports MOD services by providing the signaling interface to establish, maintain, and release client initiated exclusive sessions.

A service application manager (SAM) server 25 is a server component of a client-server pair of components, with the client component being located at the DHCT 16. Together, the client-server SAM components provide a system in which the user can access services that are identified by an application to run and a parameter specific to that service; an example of an application is the Watch-TV application 62 (FIG. 3), and an example of a parameter is the ABC channel. The client-server SAM components also manage the life cycle of the applications on the system, including the definition, activation, and suspension of services they provide and the downloading of the applications into the DHCT 16 as necessary.

Applications on both the headend 11 and the DHCT 16 can access the data stored in a broadcast file system (BFS) server 28 in a similar manner to a file system found on operating systems. The BFS server 28 and its counterpart, the BFS client module 43 (FIG. 3), are part of a file broadcasting system. The BFS server 28 repeatedly sends data for applications on a data carousel (not shown) over a period of time in a cyclical manner so that a DHCT 16 may access the data as needed.

A VOD content manager 21 is responsible for managing the content on the VOD content servers 22. The MOD application server 19 controls both the VOD content manager 21 and the VOD content servers 22 and utilizes them to help deliver the video and audio streams that make up VOD services. In one embodiment, an MOD content manager and MOD content servers (not shown) could run respectively in parallel to the VOD content manager 21 and VOD content servers 22 to manage other types of on-demand media content. In an alternate embodiment an MOD content manager replaces the VOD content manager 21 and the MOD content servers replaces the VOD content servers 22. The QAM modulators that comprise the QAM group 24 receive MPEG-2 transport streams from the VOD content servers 22, convert them into encrypted RF signals at a specified frequency (channel), and transmit them to a DHCT 16 via the network 18.

A QPSK modem 26 is responsible for transporting the out-of-band IP (internet protocol) datagram traffic between the distribution headend 11 and a DHCT 16. Data from the QPSK modem 26 is routed by a headend router 27. The headend router 27 is also responsible for delivering upstream application traffic to the various application servers 19 & 20.

Media presentations received from a content provider 10 via communication interface 36 is stored in one or more media storage devices 37. Such media presentations include television programs that are scheduled to be broadcast at a later time. In accordance with one embodiment of the invention a user is provided via DHCT 16 (FIG. 3) with the option of viewing a media presentation stored in media storage device 37 in advance of its scheduled broadcast time.

FIG. 3 is a block diagram illustrating a DHCT 16 that is coupled to a headend 11 and to a television 41. Some of the functionality performed by applications executed in the DHCT 16 (such as the MOD client application 63) may instead be performed at the headend 11 and vice versa. A DHCT 16 is typically situated at a user's residence or place of business and may be a stand alone unit or integrated into another device such as, for example, a television set or a personal computer. The DHCT 16 preferably includes a communications interface 42 for receiving signals (video, audio and/or other data) from the headend 11 through the network 18 and for providing any reverse information to the headend 11 through the network 18. The DHCT 16 further includes at least one processor 44 for controlling operations of the DHCT 16, an output system 48 for driving the television display 41, and a tuner system 45 for tuning into a particular television channel to be displayed and for sending and receiving various types of data or media from the headend 11. The tuner system 45 includes, in one implementation, an out-of-band tuner for bi-directional quadrature phase shift keying (QPSK) data communication and a quadrature amplitude modulation (QAM) tuner for receiving television signals. Additionally, a receiver 46 receives externally-generated information, such as user inputs or commands from other devices.

The DHCT 16 may also include one or more wireless or wired interfaces, also called ports, for receiving and/or transmitting data to other devices. For instance, the DHCT 16 may feature USB (Universal Serial Bus), Ethernet (for connection to a computer), IEEE-1394 (for connection to media devices in an entertainment center), serial, and/or parallel ports. The user inputs may, for example, be provided by a computer or transmitter with buttons or keys located either on the exterior of the terminal or by a hand-held remote control device or keyboard that includes user-actuated buttons.

In one implementation, the DHCT 16 includes system memory 49, which includes flash memory 51 and dynamic random access memory (DRAM) 52, for storing various applications, modules and data for execution and use by the processor 44. Basic functionality of the DHCT 16 is provided by an operating system 53 that is primarily stored in flash memory 51. Among other things, the operating system 53 includes at least one resource manager 67 that provides an interface to resources of the DHCT 16 such as, for example, computing resources.

One or more programmed software applications, herein referred to as applications, are executed by utilizing the computing resources in the DHCT 16. Applications stored in flash memory 51 or DRAM 52 are executed by one or more processors 44 (e.g., a central processing unit or digital signal processor) under the auspices of the operating system 53. Data required as input by an application is stored in DRAM 52 or flash memory 51 and read by processor 44 as need be during the course of the application's execution. Input data may be data stored in DRAM 52 by a secondary application or other source, either internal or external to the DHCT 16, or possibly anticipated by the application and thus created with the application at the time it was generated as a software application, in which case it is stored in flash memory 51. Data generated by an application is stored in DRAM 52 by processor 44 during the course of the application's execution. DRAM 52 also includes application memory 70 that various applications may use for storing and/or retrieving data.

An application referred to as navigator 55 is also resident in flash memory 51 for providing a navigation framework for services provided by the DHCT 16. The navigator 55 registers for and in some cases reserves certain user inputs related to navigational keys such as channel increment/decrement, last channel, favorite channel, etc. The client applications may be resident in flash memory 51 or downloaded into DRAM 52. The navigator 55 also provides users with television related menu options that correspond to DHCT functions such as, for example, providing an interactive program guide, blocking a channel or a group of channels from being displayed in a channel menu, and displaying a video-on-demand purchase list.

The flash memory 51 also contains a platform library 56. The platform library 56 is a collection of utilities useful to applications, such as a timer manager, a compression manager, a configuration manager, an HTML parser, a database manager, a widget toolkit, a string manager, and other utilities (not shown). These utilities are accessed by applications via application programming interfaces (APIs) as necessary so that each application does not have to contain these utilities. Two components of the platform library 56 that are shown in FIG. 3 are a window manager 59 and a service application manager client (SAM) 57.

The window manager 59 provides a mechanism for implementing the sharing of the screen regions and user input. The window manager 59 on the DHCT 16 is responsible for, as directed by one or more applications, implementing the creation, display, and de-allocation of the limited DHCT 16 screen resources. It allows multiple applications to share the screen by assigning ownership of screen regions, or windows. The window manager 59 also maintains, among other things, a user input registry 50 in DRAM 52 so that when a user enters a key or a command via the RC 80 or another input device such as a keyboard or mouse, the user input registry 50 is accessed to determine which of various applications running on the DHCT 16 should receive data corresponding to the input key and in which order. As an application is executed, it registers a request to receive certain user input keys or commands. When the user presses a key corresponding to one of the commands on the RC 80, the command is received by the receiver 46 and relayed to the processor 44. The processor 44 dispatches the event to the operating system 53 where it is forwarded to the window manager 59 which ultimately accesses the user input registry 50 and routes data corresponding to the incoming command to the appropriate application.

The SAM client 57 is a client component of a client-server pair of components, with the server component being located on the headend 11. A SAM database 60 in DRAM 52 includes a data structure of services and a data structure of channels that are created and updated by the headend 11. Many services can be defined using the same application component, with different parameters. Examples of services include, without limitation and in accordance with one implementation, presenting television programs (available through a WatchTV application 62), pay-per-view events (available through a PPV application 64), digital music (not shown), media-on-demand (available through an MOD application 63), and an interactive program guide. In general, the identification of a service includes the identification of an executable application that provides the service along with a set of application-dependent parameters that indicate to the application the service to be provided. As a non-limiting example, a service of presenting a television program could be executed with a set of parameters to view HBO or with a separate set of parameters to view CNN. Each association of the application component (tune video) and one parameter component (HBO or CNN) represents a particular service that has a unique service I.D. The SAM client 57 also interfaces with the resource manager 67, as discussed below, to control resources of the DHCT 16.

Application clients can also be downloaded into DRAM 52 at the request of the SAM client 57, typically in response to a request by the user or in response to a message from the headend. In this non-limiting example DRAM 52 contains an IPG application 72, a media-on-demand application (MOD) 63, an e-mail application 65, and a web browser application 66, among others (not shown). It should be clear to one with ordinary skill in the art that these applications are not limiting and merely serve as examples for this present embodiment of the invention. Furthermore, one or more DRAM based applications may, as an alternative embodiment, be resident in flash memory 51. These applications, and others provided by the cable system operator, are top level software entities on the network for providing services to the user.

In one implementation, applications executing on the DHCT 16 work with the navigator 55 by abiding by several guidelines. First, an application utilizes the SAM client 57 for the provision, activation, and suspension of services. Second, an application shares DHCT 16 resources with other applications and abides by the resource management policies of the SAM client 57, the operating system 53, and the DHCT 16. Third, an application handles situations where resources are only available with navigator 55 intervention. Fourth, when an application loses service authorization while providing a service, the application suspends the service via the SAM (the navigator 55 will reactivate an individual service application when it later becomes authorized). Finally, an application client is designed to not have access to certain user input keys reserved by the navigator (i.e., power, channel +/−, volume +/−, etc.).

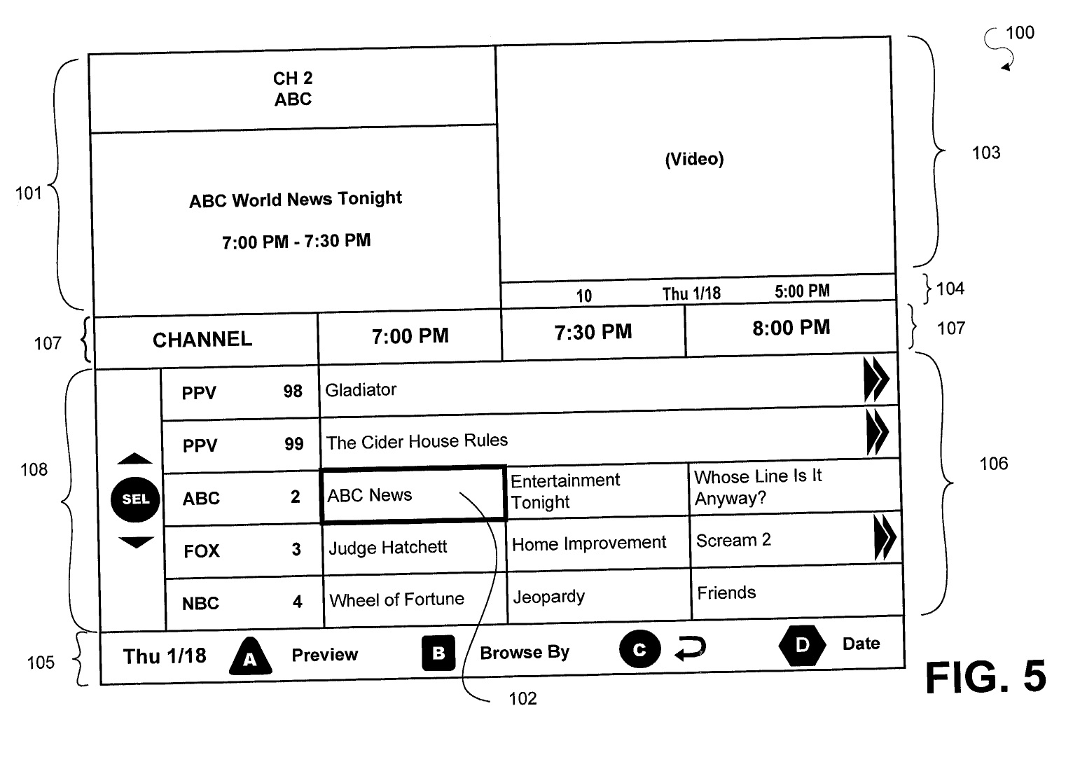

The IPG application 72 provides a user with IPG screens such as IPG screen 100 illustrated in FIG. 5, discussed in more detail below. Information contained in an IPG screen is retrieved by IPG application 72 from application memory 70. A user can request to see a future television program (FTV) by selecting it using the RC 80. An FTV is defined as a media presentation or event that is scheduled to be broadcast at a later time. In a preferred embodiment an FTV is stored at a headend 11 until requested by a user. However, an FTV may be stored at various locations within or outside the CTS 9 such as, for example, at a hub 12, at a node 13, or at a content provider 10. The MOD client application 63 provides FTVs to a user by engaging, preferably, in a direct two-way IP (Internet Protocol) connection with VOD content servers 22 (FIG. 3).

A cable services provider (CSP) would preferably enter into an agreement with the owner of an FTV regarding the terms and conditions under which an FTV is provided to a user. For example, the two parties may agree on terms such as when and how a user can be provided with an FTV, what price should be charged, how revenues are to be divided, whether advertising content is to be included, whether trick mode functionality would be available, and/or whether such functionality would be operational during an advertisement, etc.

User access to FTVs would be limited to currently available FTVs. For example, a CSP would, of course, not be able to provide a user with a future live television program prior to the time that the live program is recorded. Furthermore, a CSP would be limited by what content providers provide to the CSP. For example, the station broadcasting an FTV may refuse to provide the CSP with the FTV in advance of its scheduled broadcast time, in which case, the CSP may be unable to provide a user with such FTV.

An FTV may be delivered using a video-on-demand (VOD) delivery method, a near-video-on-demand (NVOD) delivery method, a Pay Per View delivery method, or some other delivery method. A VOD delivery method is defined as a method whereby a requested media presentation is transmitted to a particular user in response to a request by the user for the media presentation (hence the name video-on-demand). An NVOD delivery method is typically any delivery method whereby some or all of a media presentation requested by a user is not transmitted to a user in response to a request by the user. One example of NVOD is where portions of a media presentation are broadcast at prescheduled times. In this example, if a beginning portion is broadcast frequently enough, then a user may only have to wait a few minutes to begin receiving his requested media presentation. The following are non-limiting examples of delivery methods that can be used to provide a future television program to a user:

1) A beginning portion of a selected FTV is transmitted as a VOD stream while a previously broadcast NVOD stream containing the selected FTV is being stored in a DHCT buffer memory (not shown). After the VOD stream is displayed, the remainder of the FTV is supplied from the buffered NVOD stream. In this manner a user is quickly provided with the requested FTV but without using all the bandwidth required by a VOD stream.

2) A beginning portion of a popular FTV is repeatedly and more frequently broadcast to users than the remaining portion(s). Therefore, when a user requests an FTV, the user only has to wait a very short period of time before the pre-scheduled beginning portion is received. Then, by the time that a user has finished watching the beginning portion of the FTV, another portion is being received and buffered by the DHCT so that it can be “spliced” with the end of the beginning portion.

3) During periods of high demand, users are asked to wait for a short time before receiving a requested FTV so that several users can be served using a single video stream.

4) Initial segments of one or more FTVs are stored at a DHCT. After a user selects an FTV, the initial segment for the FTV is provided to the user from DHCT memory while the remainder of the FTV is being downloaded.

In addition to having various methods for providing users with access to FTVs, there are also various methods for charging users for access to FTVs. In some instances, billing software at the headend 11 can be used to determined prices to be charged for FTVs, in other instances, the prices may be determined by a content provider 10. The following are nonlimiting examples of ways that access to FTVs could be sold or marketed to users:

a) A user can subscribe to receive FTVs as part of a package of services that includes other benefits such as, for example, the ability to also access previously broadcast television programs.

b) A user can subscribe to receive unlimited access to FTVs during a subscription period.

c) A user can subscribe to receive access to a limited number of FTVs.

d) A user is charged a fee in connection with each FTV that the user requests and receives.

e) A price charged for an FTV depends on whether trick mode functionality is provided with the FTV.

f) A price charged for an FTV depends on whether it will include commercial interruptions.

g) A price charged for an FTV depends on a fee agreement between the CSP and the owner of the FTV.

h) A price charged for an FTV depends on the demand for it.

i) A price charged for an FTV depends on available bandwidth in the CATV system.

j) A price charged for an FTV depends on the time that it is requested.

k) A price charged for an FTV depends on the time that it is scheduled to be broadcast.

l) A price charged for an FTV depends on its length.

An executable program or algorithm corresponding to an operating system (OS) component, or to a client platform component, or to a client application, or to respective parts thereof, can reside in and execute out of DRAM 52 and/or flash memory 51. Likewise, data inputted into or outputted from any executable program can reside in DRAM 52 or flash memory 51. Furthermore, an executable program or algorithm corresponding to an OS component, or to a client platform component, or to a client application, or to respective parts thereof, can reside in flash memory 51, or in a local storage device connected to DHCT 16 and be transferred into DRAM 52 for execution. Likewise, data input for an executable program can reside in flash memory 51 or a storage device and be transferred into DRAM 52 for use by an executable program or algorithm. In addition, data outputted by an executable program can be written into DRAM 52 by an executable program or algorithm and be transferred into flash memory 51 or into a storage device for storage purposes. The present invention is not limited by where or how data and/or applications are stored or retrieved.

Each of the above mentioned applications comprises executable instructions for implementing logical functions and can be embodied in any memory for use by or in connection with an instruction execution system, apparatus, or device, such as a computer-based system, processor-containing system, or other system that can fetch and execute the instructions. In the context of this document, a “memory” can be any means that can contain, store, communicate, propagate, or transport the program for use by or in connection with the instruction execution system, apparatus, or device. The memory can be, for example but not limited to, an electronic, magnetic, optical, electromagnetic, infrared, or semiconductor system, apparatus, device, or propagation medium. More specific examples (a non-exhaustive list) of the memory would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the memory could even be paper or another suitable medium upon which the program is printed, as the program can be electronically captured, via for instance optical scanning of the paper or other medium, then compiled, interpreted or otherwise processed in a suitable manner, and then stored in a computer memory.

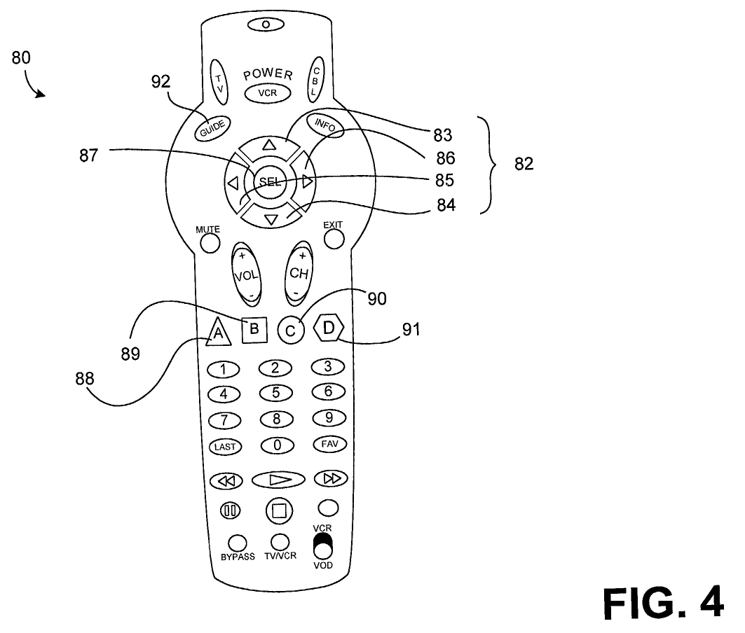

FIG. 4 illustrates a non-limiting example of a remote control device (RC) 80 that is used to provide user input to the DHCT 16. The arrow buttons 82 include an up arrow button 83, a down arrow button 84, a left arrow button 85, and a right arrow button 86 that are used to scroll through options and/or to highlight an option. The select button 87 may be used to select a currently highlighted option that is provided to the user. The guide key 92 may be used to access a television program guide, as discussed below. Many alternative methods of providing user input may be used including a remote control device with different buttons and/or button layouts, a keyboard device, a voice activated device, etc. The embodiments of the invention described herein are not limited by the type of device used to provide user input.

With continued reference to FIGS. 1-4 throughout the remaining figures, FIG. 5 is an example IPG screen 100 that illustrates an initial guide arrangement in a time format that the DHCT 16 presents to the user in response to user input, such as, for example, the activation of the guide key 92. The top left portion of the main IPG screen 100 is a detailed focus area 101 that includes detailed channel information (channel number, channel name (ABC), program name, program description, duration, any episode information or rating, etc.) for an “in-focus” program corresponding to highlighted program area 102 in a main program display area 106. Video showing on the channel to which the DHCT 16 is currently tuned (for which audio is also playing, and which is typically the program occupying the full screen before the user is presented with IPG screen 100) is displayed in a roughly one-quarter screen current program video area 103 in the IPG screen 100. Immediately below the current program video area 103 is an information banner 104 depicting the channel to which the DHCT 16 is currently tuned, the current day and date, and the current time. The middle left portion of the IPG screen 100 includes a channel area 108 that is related to the selected ordering format and is described in more detail below. The middle portion of the IPG screen 100 includes a heading portion 107 that contains headings related to the information displayed in the channel area 108 and the main program display area 106. The main program display area 106 contains television program titles corresponding to television programs that are or will be available for viewing during the time periods listed under the heading portion 107. The highlighted program area 102 is centered in the main program display area 106 enabling the subscriber to scroll up and down to the various program titles listed in the main program display area 106.

The main program display area 106 includes program names organized in a grid of rows of channels and columns of time. The channel area 108 includes a vertical list of channels organized sequentially from top to bottom by increasing channel number. The main program display area 106 can be scrolled in both time and channel number dimensions. The time dimensions are a horizontal array of program names categorized in columns of times in which they are broadcast. As the subscriber scrolls in time across a calendar day boundary, the selected day displayed in various areas is automatically updated.

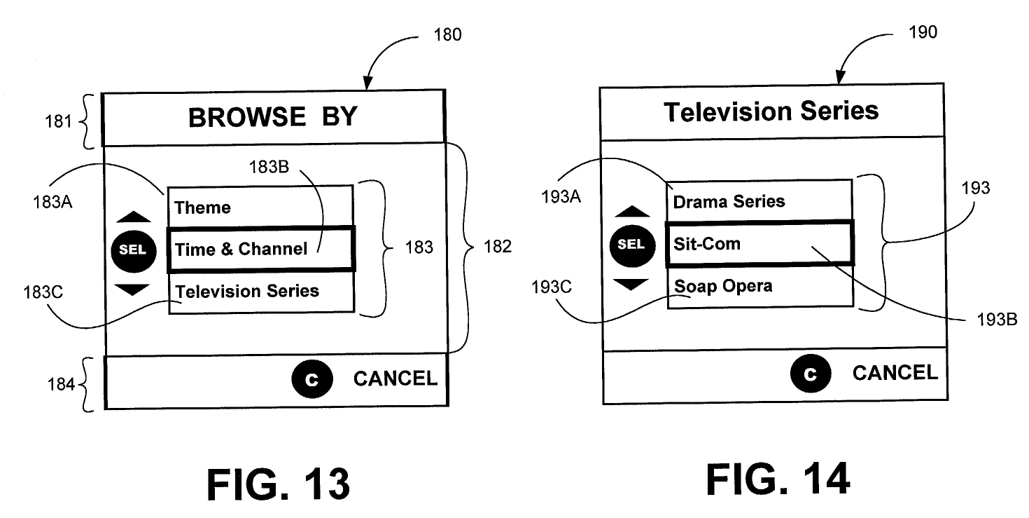

When the IPG application is first activated by the subscriber and the time view is configured to be the initial view, the first, or lowest, channel, including channel name and number, in the channel lineup is centered in the channel portion of the IPG display 108. In this non-limiting example, the lowest channel in this channel list displayed in the channel area 108 is ABC, which is shown as channel 2. Continuing with this non-limiting example, the left-most time column in the main program display area 106 is set to include titles of programs scheduled to be broadcast about two hours into the future with the middle title being “in-focus” and corresponding to a program on the lowest channel. Therefore, in this example, the program ABC News which is on channel 2, is centered in the highlighted program area 102. It should be noted that the current program shown in current program video area 103 and referenced in information banner 104, corresponds to channel 10 and not to the in-focus program on channel 2. The bottom area 105 of IPG screen 100 indicates the selected day for which program data is being displayed as well as information about the current functions of the “A”, “B”, and “C” keys on the RC 80. The “A” key 88 is shown assigned to initiate a preview of a highlighted television program. The “B” key 89 is for accessing a browse-by menu as illustrated in FIG. 13. Operation of the “C” key 90 results in the displaying of television program titles in the main program display area 106 which correspond to television programs that are or will be playing during a time period that includes the current time, with the program title currently on the channel to which the DHCT is tuned 103 highlighted and “in focus” 102. The date in the bottom portion 105 is updated accordingly. The “D” key 91 enables the subscriber to select a different date for viewing or searching program data via the IPG screen 100.

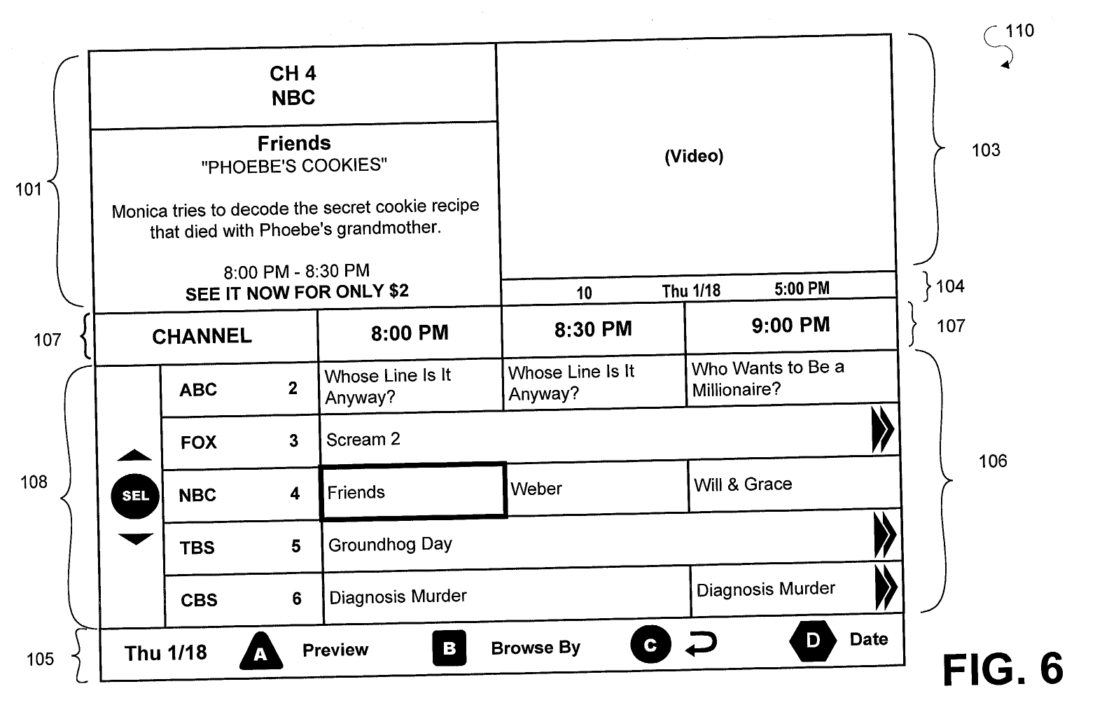

FIG. 6 is an example screen 110 illustrating the selection of an FTV. Example screen 110 is presented to the user after the user, while being presented with example screen 100, scrolls down to the NBC channel using the down arrow button 84 and then scrolls to the 8:00 PM time slot using the right arrow button 86. In this non-limiting example, the television show “Friends” is scheduled to be broadcast at 8:00 PM (i.e. three hours after the “current” time of 5:00 PM). By selecting the FTV “Friends” using the select button 87, an authorized user is presented with the requested TV show by the DHCT 16 as soon as the DHCT 16 begins receiving it from the headend 11 or other storage location such as hub 12 or node 13.

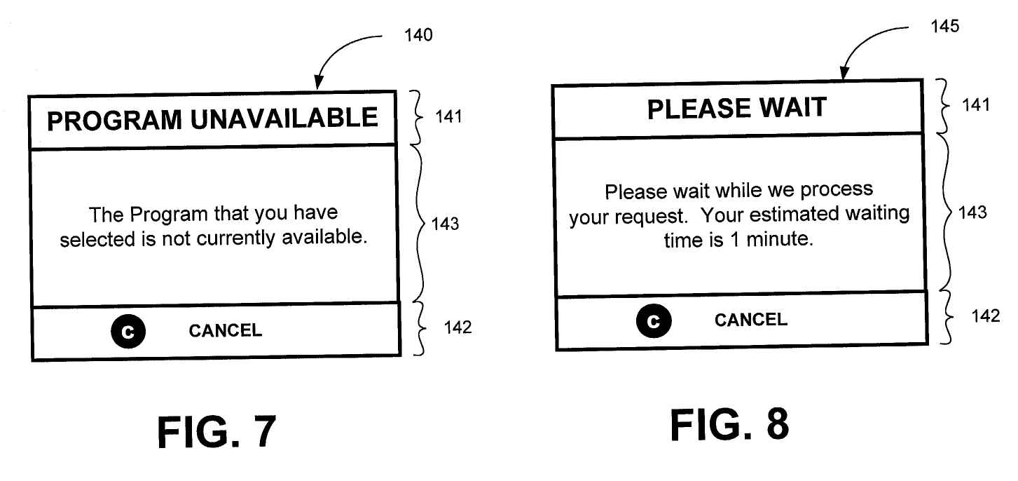

FIGS. 7 and 8 depict example information banners 140 and 145 respectively that may be presented to a user that requests a past or a future television program. Information banner 140 is presented to a user if the requested program is not currently available. A requested program may be unavailable for various reasons such as for example, if it is not stored at a headend or local server or if the program's owner has not authorized its distribution at a time of the user's request. Information banner 145 is presented to the user after the user selects an FTV and before the user receives the selected program. The information banner 145 notifies the user that the user's request is being processed and informs him of the approximate waiting period for receiving the selected television program. In one embodiment, a beginning portion of the requested FTV is previously stored in the DHCT 16 so that the user would not have to wait to begin watching the FTV. Accordingly, a user may not be instructed to wait if there is no significant lag time before the FTV is presented to the user.

A “System is Busy” banner (not shown) would be presented to a user if his request cannot be “currently” processed. A “System is Busy” banner would contain a message instructing the user to try again at a later time. A user's request may not be fulfilled if, for example, there is insufficient bandwidth at the time of the user's request.

A “Subscription Required” banner (not shown) would be presented to a user if a subscription is needed before receiving an FTV. Such a banner would inform the user that a subscription is needed before receiving an FTV and would ask the user if the user would like to purchase a subscription. If the user indicates that the user does wish to purchase a subscription for FTVs then the user is provided with a subscription banner (not shown) that the user can use to purchase a subscription.

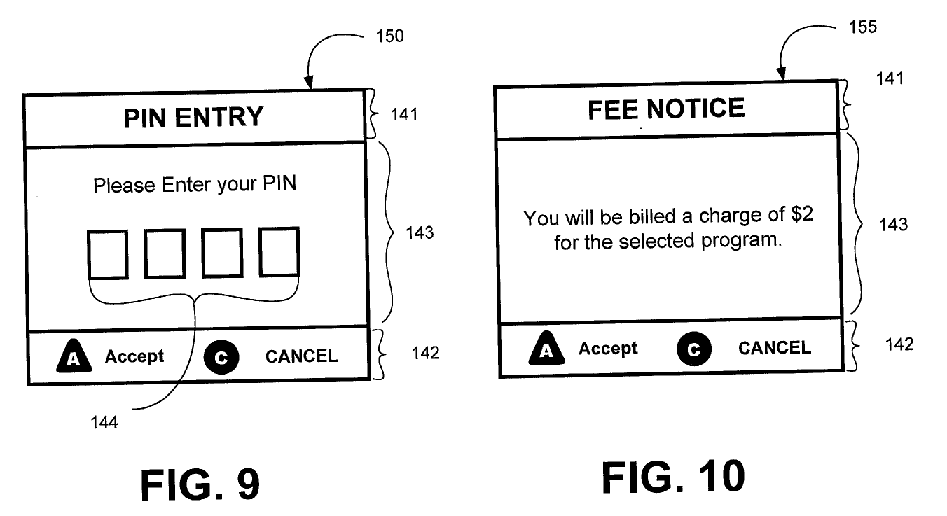

FIG. 9 is an example screen 150 illustrating a personal identification number (PIN) entry barker presented to a user after the user selects a past or a future television program for which a PIN entry is required for completing the rental transaction. In one embodiment, a user is always provided with a PIN entry barker after the user requests an FTV. In an alternative embodiment, a user may determine whether a PIN entry barker will be presented to him or to members of his household after a request for a FTV is made. A PIN may be required in order to avoid billing a user for unauthorized rental requests. The user can enter a PIN by activating the corresponding numbers on the RC 80. Once the user has finished entering a PIN, the user can activate the A button 88 to rent the television program. After the user enters a PIN, it is transmitted to the headend 11 where it is compared with a previously stored PIN corresponding to the user's DHCT 16. If the PIN entered by the user matches the previously stored PIN, then the user's request is authorized and the user may receive the requested FTV.

FIG. 10 is an example information barker 155 illustrating a step of confirming the rental of an FTV. Example screen 155 may be presented to the user after the user selects a program that has a rental fee associated with it. Of course, different programs may have different rental fees, and the user is notified accordingly. The user can activate the A button 88 to confirm the rental or the C button 90 to cancel the transaction. After the user confirms the rental, the user is provided with the requested FTV.

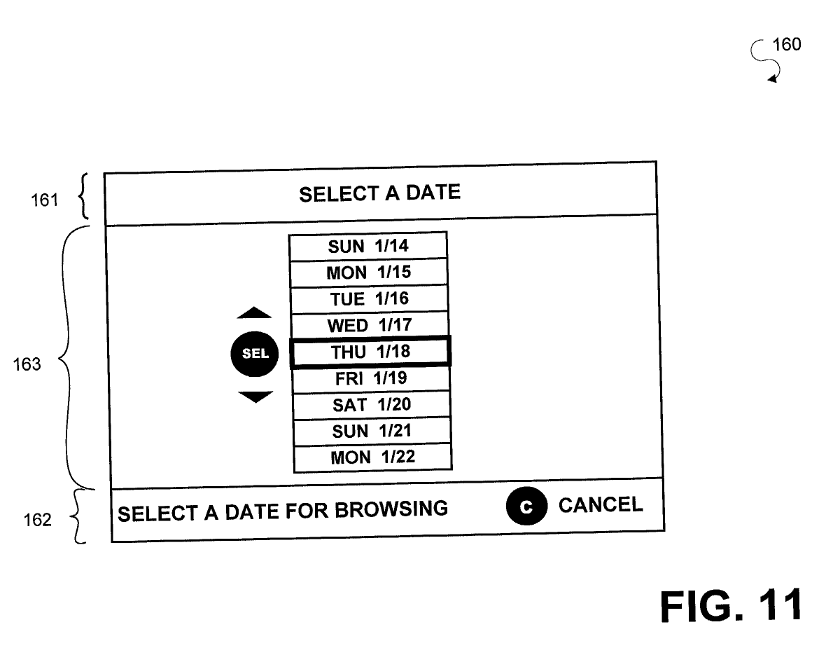

FIG. 11 is an example screen 160 illustrating a date selection menu that is presented to a user after the user activates the B button 89 while being presented with example screen 110 (FIG. 6). A message in the bottom area 105 instructs the user to select a date for browsing programs. The user can highlight a date from the date menu 121 by activating the up and down arrow buttons 83 and 84 on the RC 80. The user can then activate the select button 87 to designate a currently highlighted date as the date for which program information is presented in the main program display area 106.

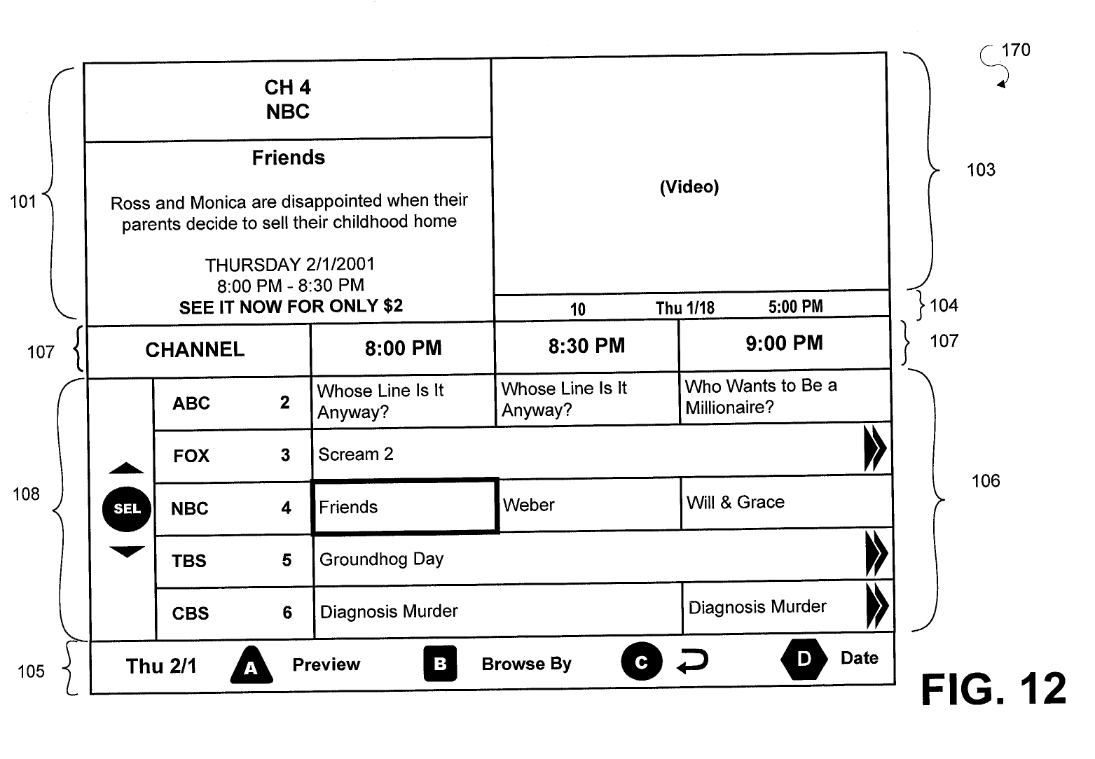

FIG. 12 is an example screen 170 illustrating the selection of Thursday 2/1 as the date for which program information is presented. Example screen 170 is presented to a user after the user selects Thursday 2/1 via example screen 160. The programs currently displayed in the main program display area 106 are FTVs that are scheduled to be broadcast at on Thursday February 2. Nevertheless, a user can still view an FTV by selecting it using the RC 80. For example, a user can select the future episode of “Friends” by activating the select button 87. Alternatively, the user may, for example, select a future episode of “Will & Grace.” If for some reason the TV show that is selected by the user is not available, the user is notified accordingly as illustrated in FIG. 7. However, if the FTV is available, then the user is presented with the show. The user is also notified if the user has to wait while his request is being processed as illustrated in FIG. 8.

FIG. 13 is an example screen diagram that illustrates a browse by screen 180 that is presented to a user after the user activates the B button 89 while being presented with an IPG screen such as, for example, IPG screen 100 (FIG. 5). Browse-by screen 180 has a top, a middle and a bottom portion; top portion 181 contains the heading “Browse By”, middle portion 182 contains a browse-by menu 183, and bottom portion 184 contains one or more navigation instructions. Browse-by menu 183 includes options for browsing through television program information. As a non-limiting example, options 183A, 183B and 183C would respectively provide access to television program information arranged by theme (such as comedy, drama, action, etc.), by time and channel as illustrated in FIG. 5, and by television series as illustrated in FIG. 14.

FIG. 14 is an example screen diagram that illustrates a television series selection screen 190 that is presented to a user after the user selects the television series option 183C while being presented with browse by screen 180 (FIG. 13). Selection screen 190 has a top portion 191 containing the heading “Television Series” and a middle portion 192 containing a television series selection menu 193. Selection menu 193 includes selections corresponding to types of television series. As a non-limiting example, options 193A, 193B and 193C would respectively provide access to past and future episodes from drama series, sit-coms and soap operas.

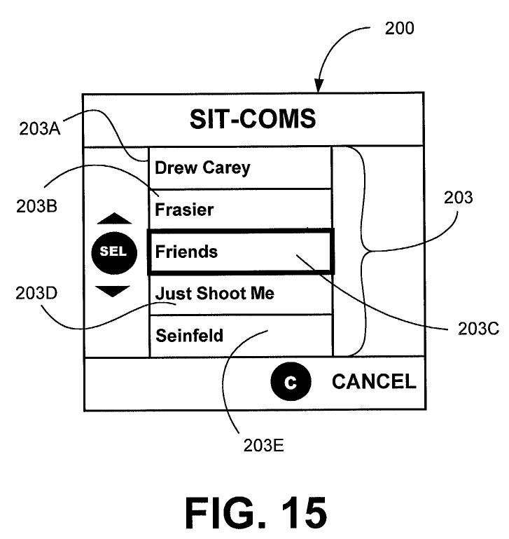

FIG. 15 is an example screen diagram that illustrates a sit-com selection screen 200 that is presented to a user after the user selects the sit-com option 193B while being presented with the television series selection menu 190 (FIG. 14). Selection screen 200 has a sit-com selection menu 203 containing sit-com selections. As a non-limiting example, selections 203A-203E would respectively provide access to episodes from the sit-coms Drew Carey, Frasier, Friends, Just Shoot Me, and Seinfeld.

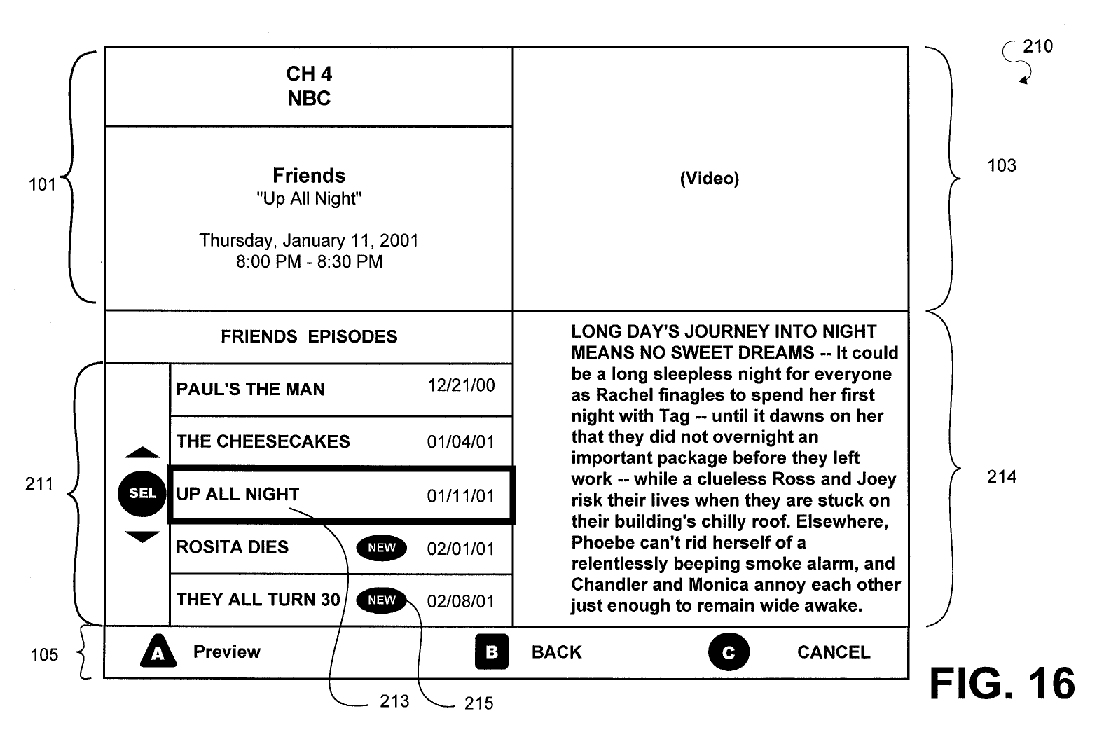

FIG. 16 is an example screen diagram that illustrates an episode selection screen 210 that is presented to a user after the user selects the Friends option 203C while being presented with the sit-com selection menu 200 (FIG. 15). Selection screen 210 has an episode selection menu 211 containing Friends episode selections. Information area 214 contains information about the content of the highlighted episode selection 213 which in this example is “Up All Night” whereas detailed focus area 101 contains information about the corresponding time, date, channel and station. Selections corresponding to future episodes that have not yet been broadcast are labeled as such via a “NEW” label 215.

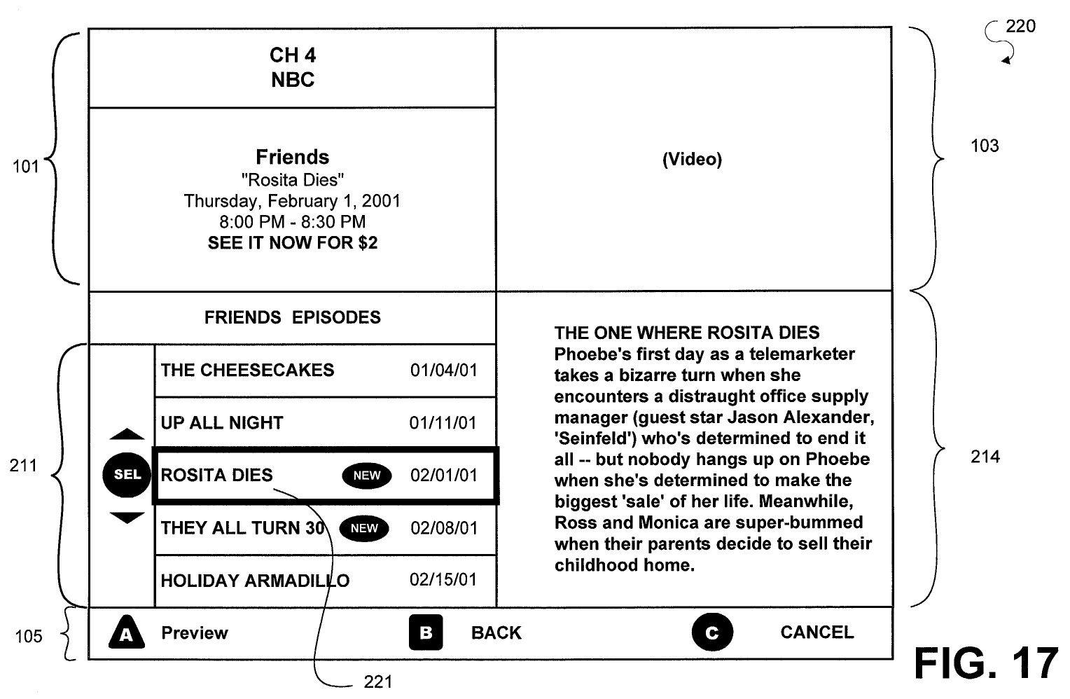

FIG. 17 is an example screen diagram that illustrates an episode selection screen 220 that is presented to a user after the user activates the down arrow button 84 while being presented with episode selection screen 210 (FIG. 16). Information area 214 contains information about the content of the highlighted episode selection 221 which in this example is “Rosita Dies” whereas detailed focus area 101 contains information about the corresponding time, date, channel, station, and rental price. By activating the select button, a user can request the future episode “Rosita Dies”.

It should be emphasized that the above-described embodiments of the present invention, particularly any “preferred embodiments”, are merely possible examples of the implementations, merely setting forth a clear understanding of the principles of the invention. All examples described above, particularly any example screens or barkers, are intended to be non-limiting examples, and as such, are not intended to limit the scope of the invention. Many variations and modifications may be made to the above-described examples and embodiments without departing substantially from the spirit of the principles of the invention. All such modifications and variations are intended to be included herein within the scope of the disclosure and present invention and protected by the following claims.

What is claimed is:

1. A method for providing media services via an interactive media services client device coupled to a programmable media services server device, said method comprising:
providing a user with an interactive program guide (IPG) identifying a future television program, said television program scheduled to be broadcast at a later time;
receiving user input requesting said future television program; and
providing said user with said future television program prior to said later time.

2. The method of claim 1, further comprising:
confirming that said user is authorized to receive said future television program.

3. The method of claim 1, further comprising:
charging said user a fee in connection with the provision of said television program.

4. The method of claim 1, further comprising:
charging said user a fee in connection with providing said user with access to future television programming.

5. The method of claim 1, wherein said IPG identifies a plurality of episodes corresponding to a television show.

6. The method of claim 5, wherein a type of said television show is from a group consisting of:
a sit-com, a drama series, and a soap opera.

7. The method of claim 1, wherein said IPG identifies a plurality of television programs and a plurality of corresponding channels and start times.

8. The method of claim 1, wherein said user input is provided via a remote control device and said future television program is displayed on a television screen.

9. The method of claim 1, wherein said future television program is received from a headend.

10. The method of claim 1, wherein said future television program is received from a content provider.

11. The method of claim 1, wherein said future television program is stored in a memory located inside said client device.

12. The method of claim 1, wherein said future television program is stored in a storage device coupled to said client device.

13. The method of claim 1, wherein said future television program is stored in a storage device located in a hub.

14. The method of claim 1, wherein said future television program is stored in a storage device located in a node.

15. The method of claim 1, wherein said future television program is stored in a storage device located in a cable television system.

16. The method of claim 1, wherein said future television program is stored in a storage device coupled to a cable television system.

17. The method of claim 1, wherein said user is also provided with access to a previously broadcast television program identified in said interactive program guide.

18. The method of claim 1, wherein said user is also provided with access to a currently broadcast television program identified in said interactive program guide.

19. A media services device for providing a user with a media presentation, said device comprising:
logic configured to provide said user with an interactive program guide (IPG) identifying a future television program, said future television program scheduled to be broadcast at a later time; and
logic configured to provide said user with said future television program prior to said later time in response to receiving user input requesting said future television program.

20. The media serviced device of claim 19, further comprising:
logic configured to cause said user to be charged a fee in connection with the provision of said television program.

21. The media serviced device of claim 19, further comprising:
logic configured to cause said user to be charged a fee in connection with providing the user with access to future television programming.

22. The media serviced device of claim 19, further comprising:
logic configured to confirm that said user is authorized to receive said future television program.

23. The media serviced device of claim 19, wherein said IPG identifies a plurality of episodes corresponding to a television show.

24. The media serviced device of claim 23, wherein a type of said television show is from a group consisting of:
a sit-com, a drama series, and a soap opera.

25. The media serviced device of claim 19, wherein said IPG identifies a plurality of television programs and a plurality of corresponding channels and start times.

26. The media serviced device of claim 19, wherein said user input is provided via a remote control device and said future television program is displayed on a television screen.

27. The media serviced device of claim 19, wherein said future television program is received from a headend.

28. The media serviced device of claim 19, wherein said future television program is stored in a memory located inside said client device.

29. The media serviced device of claim 19, wherein said future television program is stored in a storage device coupled to said client device.

30. The media serviced device of claim 19, wherein said future television program is stored in a storage device located in a hub.

31. The media serviced device of claim 19, wherein said future television program is stored in a storage device located in a node.

32. The media serviced device of claim 19, wherein said future television program is stored in a storage device located in a cable television system.

33. The media serviced device of claim 19, wherein said future television program is stored in a storage device coupled to a cable television~system.

34. The media serviced device of claim 19, further comprising logic configured to provided said user with access to a previously broadcast television program identified in said interactive program guide.

35. The media serviced device of claim 19, further comprising logic configured to provided said user with access to a currently broadcast television program identified in said interactive program guide.
